(19) United States
(12) Patent Application Publication
(10) Pub. No.: US 2016/0368277 A1
(43) Pub. Date: Dec. 22, 2016

(54) FILM FOR PRINTED HYDROGRAPHICS AND METHODS OF MAKING AND USING THE SAME

(71) Applicant: AMERICAN HYDROGRAPHICS, CHAMPLIN, MN (US)

(72) Inventors: STEPHEN LAWSON PETERSON, WAYZATA, MN (US); CLAY MATTHEW REIERSON, COON RAPIDS, MN (US); FRANK WILLIAM SHERMAN, WHITE BEAR LAKE, MN (US)

(73) Assignee: AMERICAN HYDROGRAPHICS, CHAMPLIN, MN (US)

(21) Appl. No.: 14/919,141

(22) Filed: Oct. 21, 2015

Related U.S. Application Data
(60) Provisional application No. 62/180,381, filed on Jun. 16, 2015.

(51) Int. Cl. B41J 3/407

(52) U.S. Cl. CPC B41J 3/407

(57) ABSTRACT

A system for digitally printing a hydrographic design on a water-soluble film, the system including a source roll of a water-soluble film, the source roll disposed on a tensioned unwind roller, a digital printer, a temporary support for the water-soluble film maintained during partial transport of the water-soluble film through the digital printer from the unwind roller to a powered rewind roller and a tension roller or a spread roller for maintaining controlled tension to the water-soluble film, wherein the water soluble film once wound upon the powered rewind roller is linerless.

### CROSS-REFERENCE TO RELATED APPLICATIONS

This application claims priority under 35 U.S.C. §119 to U.S. Provisional Application Ser. No. 62/180,381, filed Jun. 16, 2015, the entirety of which is incorporated herein by reference.

### BACKGROUND OF THE INVENTION

The present invention relates to improved films for printed hydrographics, and to methods of making and using the same.

The market for printed hydrographics, also commonly referred to as immersion printing or water transfer printing, is growing rapidly due to the ease with which three-dimensional articles can be decorated and transformed simply by floating a printed hydrographic in a water-filled container, allowing the water-soluble film on the printed hydrographics to liquefy, applying an activator, and then lowering the article into the water through the floating ink layer. The ink wraps around the article and adheres itself thereto providing the article with the image from the printed hydrographic design.

Printed hydrographics are typically formed by printing the desired graphic design on a very thin film of water-soluble polymer, commonly polyvinyl alcohol (PVA).

Such water-soluble polymer films are very sensitive to heat, moisture and mechanical stresses that may occur during printing processes, and are thus limited to use with certain types of printing processes and are subjected to slower line speeds to avoid stress on the film. PVA is currently printed at line speeds of only up to about 100 feet/minute.

U.S. Pat. No. 6,953,511 is directed to a method of high definition printing for dip transfer of hydrographic designs onto three dimensional articles using thin polyvinyl alcohol films which are not suitable for digital printing or high speed printing such as gravure printing.

There remains a need in the art for improved systems, methods and substrates for printing of hydrographic designs.

Without limiting the scope of the invention a brief summary of some of the claimed embodiments of the invention is set forth below. Additional details of the summarized embodiments of the invention and/or additional embodiments of the invention may be found in the Detailed Description of the Invention below.

### SUMMARY OF THE INVENTION

In one aspect, the present invention relates to a system for digitally printing a hydrographic design on a water-soluble film, the system including a source roll of a water-soluble film, the source roll disposed on a tensioned unwind roller, a digital printer, a temporary support for the water-soluble film maintained during partial transport of the water-soluble film through the digital printer from the unwind roller to a powered rewind roller and a tension roller or a spread roller for maintaining controlled tension to the water-soluble film, wherein the water soluble film once wound upon the powered rewind roller is linerless.

In another aspect, the present invention relates to a method of method for producing a linerless water-soluble film comprising a digitally printed hydrographic, the method including providing a source roll comprising linerless water-soluble film, the source roll disposed on an unwind roller, providing a temporary support for the water soluble film extending a partial distance between the unwind roller and a powered rewind roller and through a digital printer, transporting the linerless water-soluble film over the temporary support and through the digital printer wherein a hydrographic image is digitally printed onto the water-soluble film and winding the linerless water-soluble film comprising the digitally printed hydrographic onto the powered rewind roller.

These and other aspects, embodiments and advantages of the present disclosure will become immediately apparent to those of ordinary skill in the art upon review of the Detailed Description and Claims to follow.

### BRIEF DESCRIPTION OF THE DRAWINGS

FIG. 1 is a perspective view of one embodiment of substrate useful for printing a hydrographic design thereon.

FIG. 2 is a partial side view illustrating one method of laminating a film to a support liner and fixedly securing it thereto.

FIG. 3 is a block flow diagram illustrating one embodiment of an inline integrated method of providing an article with a hydrographic design.

FIG. 4 is a block diagram flow diagram illustrating an alternative inline integrated method of providing an article with a hydrographic design.

FIG. 5 is a block flow diagram illustrating linerless inline digital printing system for printing on water soluble polymer films.

FIG. 6 is a block flow diagram illustrating an inline digital printing system using a temporary reusable liner.

FIG. 7 is a block flow diagram illustrating an alternative linerless inline digital printing system.

FIG. 8 is a block flow diagram illustrating another embodiment of a linerless inline integrated method of providing an article with a hydrographic design.

### DETAILED DESCRIPTION

While embodiments of the present disclosure may take many forms, there are described in detail herein specific embodiments of the present disclosure. This description is an exemplification of the principles of the present disclosure and is not intended to limit the disclosure to the particular embodiments illustrated.

As used herein, the term “hydrographic design” or “hydrographics” shall refer to a process by which a printed design is transferred onto an article, particularly those that are three-dimensional, by dipping the article in a water-filled tank, referred to as immersion printing, water transfer printing, water transfer imaging or cubic printing.

This process is useful on all types of substrates including, but not limited to metal, polymer, glass, wood, ceramic, etc.

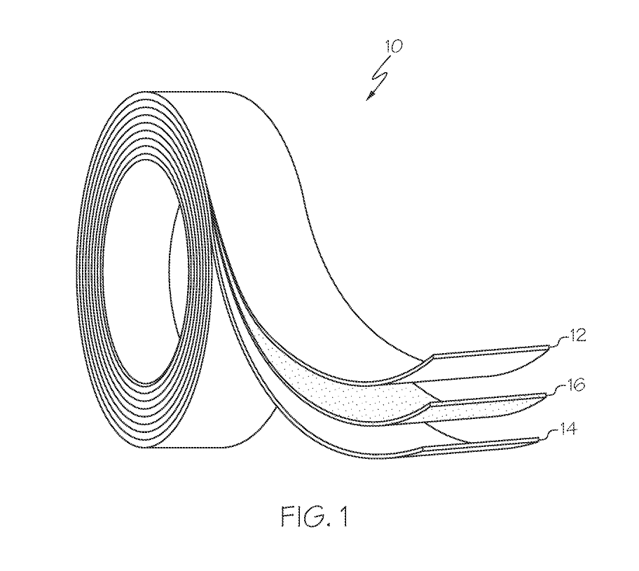

Turning now to the figures, FIG. 1 illustrates one embodiment of a substrate 10 according to the invention. In this embodiment, substrate 10 is a multilayer substrate including film 12 fixedly secured to a support liner 14. In this embodiment, the water-soluble polymer film 12 and the support liner 14 are secured using an adhesive layer 16.

Suitably, the water-soluble polymer film has a thickness of about 30 microns to about 50 microns and more suitably about 35 microns to about 40 microns.

In some embodiments, the water-soluble polymer film has a thickness of about 38 microns to about 40 microns.

The support liner may be formed from a number of suitable materials including, but not limited to paper or a paper product, non-woven fabrics, or a polymer film, suitably paper or paper product, polyester, polypropylene, polyethylene, or copolymers of terpolymers thereof.

If an adhesive is employed on the support liner, suitably the support liner includes one side to which the adhesive will not adhere. The support liner suitably has a thickness of about 2 mils to about 10 mils, and more suitably about 4 mils to about 10 mils.

In some embodiments, a 40 lb/1000 ft² paper liner is employed.

The water-soluble polymer film is suitably formed from polyvinyl alcohol (PVA), although other water-soluble polymers can be employed including, but not limited to hydroxyethyl cellulose, ethylcellulose polymers, polyacrylamides, polyethyleneimines, polymethacrylates, polyethylene oxide, polyethylene glycol, polyvinylpyrrolidone, poly(N-isopropylacrylamide), poly(2-oxaazoline), polyelectrolytes, and copolymers thereof, etc.

These lists are intended for illustrative purposes only, and not as a limitation on the scope of the present invention. Other suitable support liner materials and water-soluble polymer films could be substituted herein without departing from the scope of the present invention.

The water-soluble polymer film 12 can be fixedly secured to the support liner 14 using any method known in the art including, but not limited to, chemical bonding, adhesive bonding, mechanical bonding such as through the use of heat and pressure, electrostatic attraction, etc.

The adhesive may include any suitable adhesive known in the art including thermoplastic adhesives, thermoset adhesives, water-based adhesives, etc. Thermoset adhesives include one and two-part adhesives and may include radiation curing adhesives, for example.

Suitably, the adhesive is a pressure sensitive adhesive and is disposed on a surface of the liner, the liner having one surface to which the adhesive does not adhere, similar to that of a roll of tape.

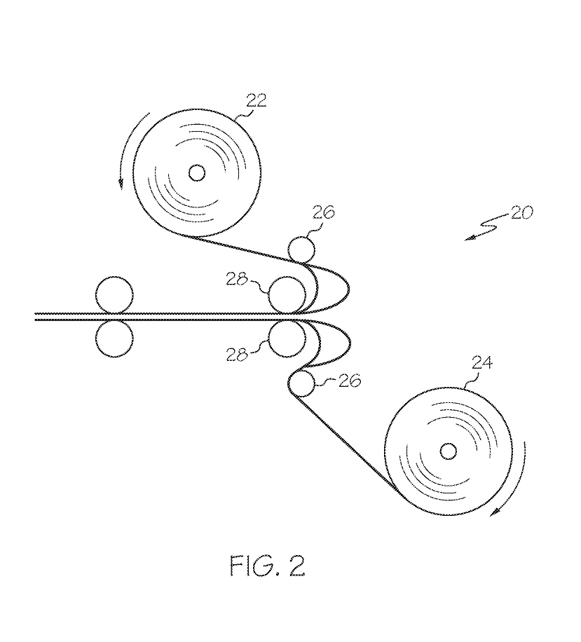

The water-soluble polymer film can be laminated to the support liner using any method known in the art. FIG. 2 is an illustration of a web-type laminator 20 in which one roll of water-soluble polymer film 22 and one roll of support liner 24 are unwound separately and pressed together at laminating rollers 28, also referred to as nip rollers in the art, the multilayer substrate of which is then wound onto a third roll (not shown). In this embodiment, support liner 24 may comprise an adhesive layer. The support liner 24 is self-wound and the adhesive layer disposed on a side of the support liner, with the alternate side of the liner being a surface to which it will not adhere, similar to a roll of tape.

The adhesively coated support liner 24 and the water-soluble polymer film may be adhered to together through the use of pressure, or heat and pressure, for example.

Alternatively, the web laminator 20 may be integrated in-line with a printing station wherein a hydrographic design is printed onto the water-soluble polymer film side of the multilayer substrate.

Any suitable transferable ink, meaning one that will transfer from the water soluble film onto the article may be employed herein. Solvent-based inks have been found to be preferable in transferring superior graphics onto an article, the invention is not limited as such. For example, water-based inks may also be employed herein.

The hydrographic design may be printed onto the film using any printing method known in the art. The present invention, wherein the multilayer substrate includes a support liner and water-soluble polymer film, the film having a thickness of about 30 microns or more, improves the mechanical strength, heat sensitivity and reduces the stress that may otherwise be put on a water-soluble polymer film such as those employed in hydrographic printing. This allows a significant advantage over previous hydrographic films in that printing methods not previously useful for hydrographic printing, such as digital printing, can be employed with the multilayer substrate disclosed herein.

The support liner and thickness also eliminate issues with stretching and or tearing of the thin water-soluble film which prevents the use of such films on high speed printing lines.

Furthermore, the increased strength and robustness of the hydrographically printed multilayer film can be bulk manufactured in rolls of about 12 inches up to about 120 inches wide, suitably about 12 inches to about 60 inches wide.

The multilayer substrate according to the invention finds particular utility for digital printing wherein a digital-based image is directly printed onto the water-soluble polymer film layer of the multilayer substrate using high-volume laser or inkjet printers. The increased rigidity provided by the support liner and the increased thickness allows for carrying of the water-soluble polymer film through the digital process including the optical registration and for stabilization during printing.

The multilayer substrate is also particularly suited for high speed/high volume gravure printing processes.

Other methods of printing the hydrographic design onto the water-soluble polymer film include, but are not limited to gravure, flexo, screen printing, three-dimensional printing and offset printing.

Furthermore, the line speeds of the printing process, such as for gravure printing, can be significantly increased from 100 feet/minute up to about 1500 feet/minute. Gravure printing is typically between about 800 feet/minute to about 1500 feet/minute. However, line speeds in general may be about 250 feet/minute to about 1500 feet/minute, about 500 feet/minute to about 1000 feet/minute, and about 800 feet/minute to 1000 feet/minute.

The web laminator and the printing station may be further integrated in-line with a dipping tank. The laminated roll, which suitably includes a large plurality of hydrographic designs, may be cut in-line using, for example, die cutting. An individual hydrographic design can then be fed to a dipping station wherein it is deposited in a water bath, an activator is applied to the water-soluble film, the water-soluble film is allowed to liquefy, and an article is then deposited therein, wherein the ink wraps around the article transferring the graphic design thereon.

Digital printing allows for “on demand” printing as desired. One advantage of digital printing is that large rolls of printed hydrographic designs do not have to be stored for periods of time.

A solvent based or cosolvent based primer layer may be provided on the water soluble or water dispersible film prior to printing to facilitate adhesion of the ink to the film. Primers can also be applied between the layers of ink. These primers may be optionally added to assist in holding an image together as it goes into the dipping tank and is applied to the article. Examples of useful solvents include, but are not limited to alcohols and acetates.

For example a cosolvent blend of 50% alcohol such as isopropyl alcohol and a 50% blend of an acetate such as n-propropyl acetate may be employed in the primer solution. Water-based primers may also be suitable for use herein.

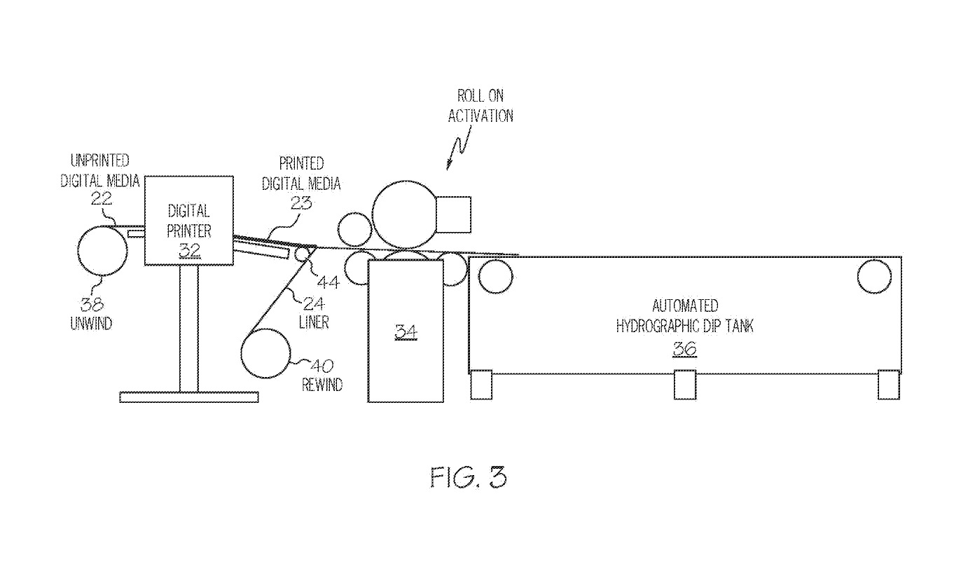

FIG. 3 is a block flow diagram illustrating one embodiment of an inline integrated process 30 of applying a hydrographic design onto an article. In this embodiment, a multilayer substrate comprising a support liner 24 and a water-soluble film 22 are unwound from a roll 38 and fed through a digital printer 32 wherein the hydrographic design is imprinted on the water soluble film 23. The liner 24 is secured to a second roll 40 wherein the liner is pulled from the water-soluble film 23 prior to the dipping tank 36. The film is fed through a roll on activation stage 34 wherein one roller picks up the chemical activator from a holding trough and another roller transfers onto it water-soluble polymer film to facilitate dissolution of the water-soluble film and to activate a bonding agent in the ink to facilitate adhesion of the ink to the substrate, and into then an automated hydrographic dip tank 36. Once the water-soluble film is liquefied, an article is dipped into the tank wherein the ink wraps around the article, imprinting the digital image thereon.

Chemical activators for hydrographic designs are well known in the art.

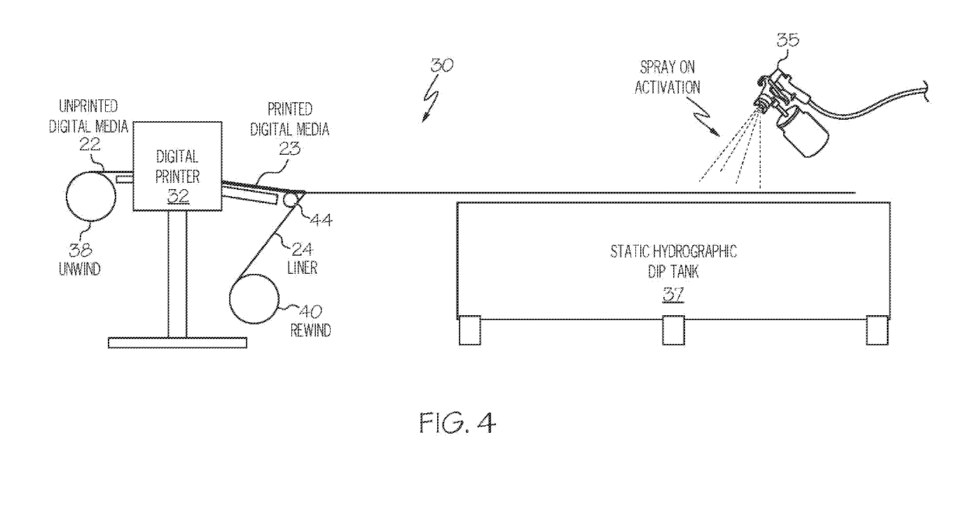

FIG. 4 is a block flow diagram illustrating an alternative in-line partially integrated process 30 wherein a static hydrographic dip tank 37 is employed. In this embodiment, a chemical activator is sprayed on the water-soluble film with a spray on activator 35 at the dipping stage wherein the digitally printed film is immersed into the dip tank.

The activator can be applied right before depositing the water-soluble film into the dipping tank, or at the time that the water-soluble film is deposited in the dipping tank.

This technique is particularly suitable for three-dimensional articles.

In other embodiments, a water-soluble film such as a polyvinyl alcohol film having no liner is employed herein. When non-linered film is employed, tension control is important for keeping the film flat while it is being printed. If the proper tension is not employed, the film may wrinkle or bunch, and print head strikes may occur to the surface of the paper which can further interfere with the print jets.

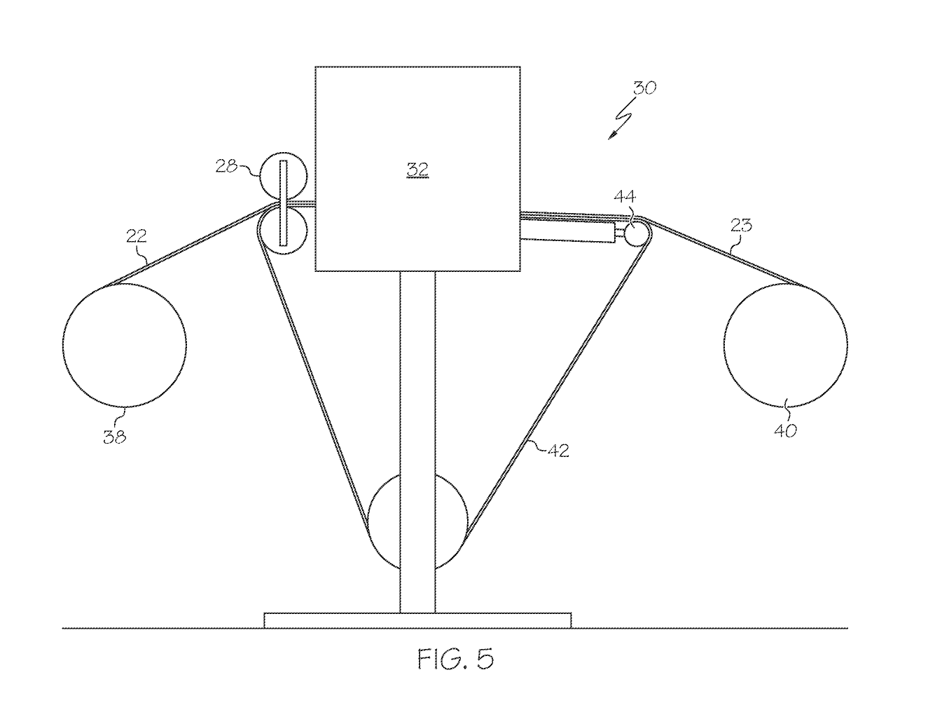

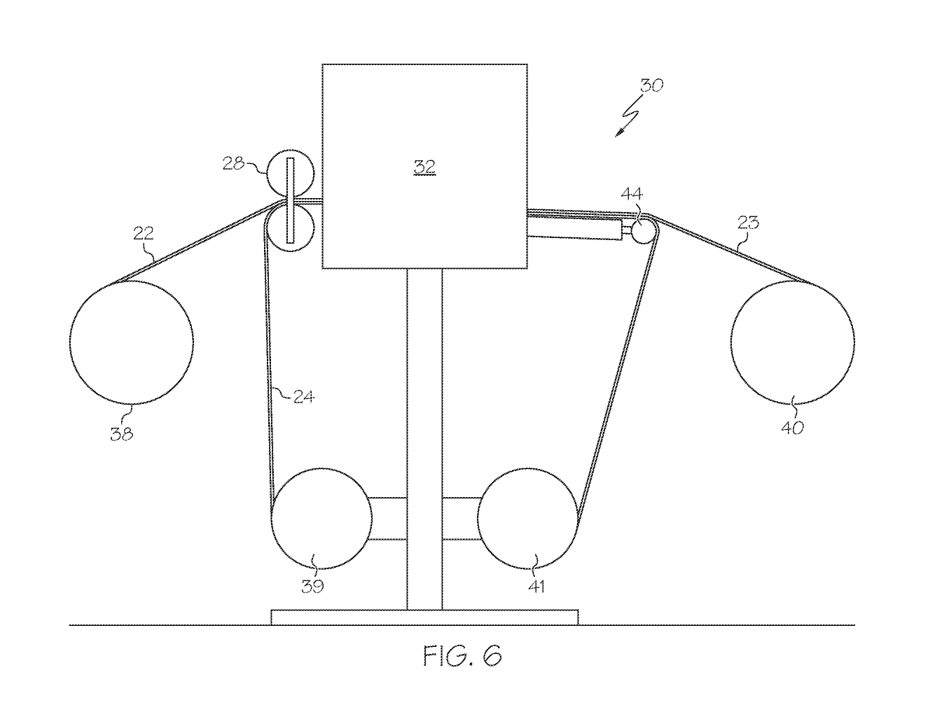

FIG. 5 illustrates an alternative embodiment wherein non-linered unprinted media 22 is employed. The unprinted media on a source roll is fed from a tensioned unwind roll 38 that is brake controlled. The unprinted media 22 is fed through a nip roller 28 to the digital printer 32 via a belt having a tacky polymer material, or otherwise has a rubberized or texturized surface, such as a silicone rubber, and to the motor driven powered rewind roll 40. The unprinted media is fed through the digital printer under tension via the tension roller 44 to prevent wrinkling, bunching or print head strikes. FIG. 6 is an alternative embodiment wherein linerless unprinted media 22 is employed. The unprinted media 22 on a source roll is fed from a tensioned unwind roller 38 thought nip rollers 28 wherein the unprinted media 22 is temporarily mated to a support liner or carrier 24 which is reusable and may be used multiple times. The unprinted media 22 while mated to the support liner or carrier 24 is fed through the digital printer and printed media 23 is then separated from the support liner and fed to a motor driven powered rewind roll 40. In this embodiment, the liner 24 on a source roll is fed through the digital printer from a liner unwind roller 39 carried through the digital printer under tension via tension roller 44 and to a liner rewind roller 41. This reduces the amount of liner that is employed in the process and is thus more economically efficient.

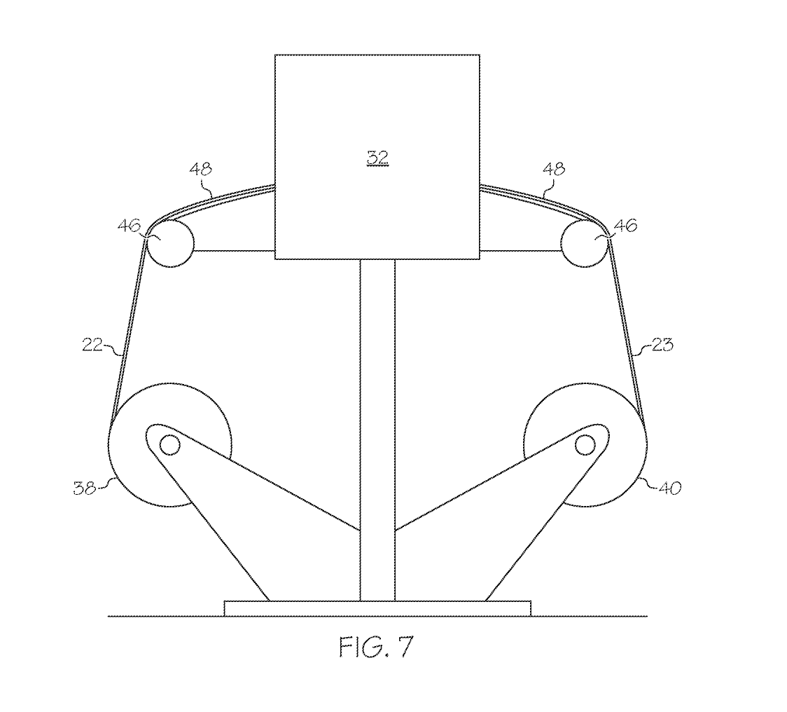

FIG. 7 is another alternative embodiment of a linerless process 30 for providing a water soluble film 22 with printed digital media. In this embodiment, the unprinted film 22 is fed from an unwind roller 38 to an arched heated platen 48 through a digital printer 32 wherein the film having digitally printed media 23 emerges. The film is kept under controlled tension via spread/tension rollers 46. The printed film 23 is then fed to a powered rewind roller 40.

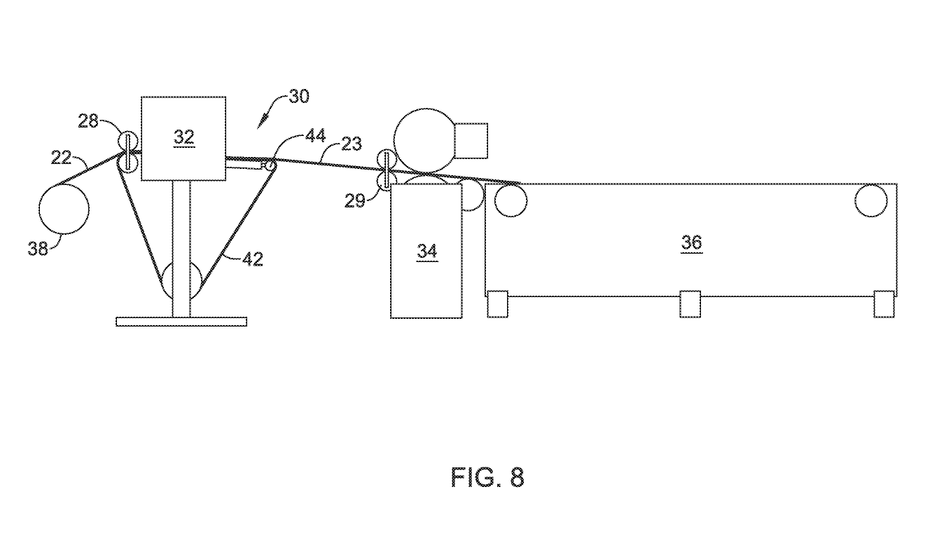

FIG. 8 illustrates an alternative embodiment of an inline integrated process 30 of applying a hydrographic design onto an article wherein non-linered unprinted media 22 is employed. The unprinted media on a source roll is fed from a tensioned unwind roll 38 that is brake controlled. The unprinted media 22 is fed through a nip roller 28 to the digital printer 32 via a belt having a tacky polymer material, or otherwise has a rubberized or texturized surface, such as a silicone rubber, and to the a second nip roller 29. The unprinted media is fed through the digital printer under tension via the tension roller 44 to prevent wrinkling, bunching or print head strikes.

In this embodiment, the linerless film is unwound from a roll 38 and fed through a digital printer 32 wherein the hydrographic design is imprinted on the water soluble film 23. The printed film is then fed through a roll on activation stage 34 wherein one roller picks up the chemical activator from a holding trough and another roller transfers onto it water-soluble polymer film to facilitate dissolution of the water-soluble film and to activate a bonding agent in the ink to facilitate adhesion of the ink to the substrate, and into then an automated hydrographic dip tank 36. Once the water-soluble film is liquefied, an article is dipped into the tank wherein the ink wraps around the article, imprinting the digital image thereon.

The inline process shown in FIG. 8 may be modified with any of the embodiments found in FIG. 4 wherein spray on activation is employed, and FIGS. 6 and 7 wherein alternative devices are employed for keeping the linerless film 22 under tension so as to prevent wrinkling, bunching and print head strikes that may occur in the linerless film 22.

The present invention is suitable for decorating a vast number of articles formed from a variety of substrates including, but not limited to, automotive accessories for trucks, cars, ATVs, snowmobiles, go karts, golf carts, motorcycles and boats, including wheels, fenders and bumpers, hoods, side panels, dashboards, steering wheels, etc., helmets, hunting equipment such as guns and bows, musical instruments such as guitar bodies, kitchen wares, hair appliances, sporting goods such as bowling balls, wheel chairs, knives, medical enclosures, furniture, office products, prosthetics, etc.

All published documents, including all US patent documents and US patent publications, mentioned anywhere in this application are hereby expressly incorporated herein by reference in their entirety. Any copending patent applications, mentioned anywhere in this application are also hereby expressly incorporated herein by reference in their entirety. Citation or discussion of a reference herein shall not be construed as an admission that such is prior art.

The description provided herein is not to be limited in scope by the specific embodiments described which are intended as single illustrations of individual aspects of certain embodiments. The methods, compositions and devices described herein can comprise any feature described herein either alone or in combination with any other feature(s) described herein. Indeed, various modifications, in addition to those shown and described herein, will become apparent to those skilled in the art from the foregoing description and accompanying drawings using no more than routine experimentation. Such modifications and equivalents are intended to fall within the scope of the appended claims.

What is claimed is:

1. A system for digitally printing a hydrographic design on a water-soluble film, the system comprising:
a source roll comprising the water-soluble film, the source roll disposed on a tensioned unwind roller;
a digital printer;
a temporary support for the water-soluble film maintained during partial transport of the water-soluble film through the digital printer from the unwind roller to a powered rewind roller; and
a tension roller or a spread roller for maintaining controlled tension to the water-soluble film;
wherein the water soluble film once wound upon the powered rewind roller, is linerless.

2. The system of claim 1 wherein the temporary support comprises a carrier belt for producing frictional contact with the water-soluble film during transport through the digital printer.

3. The system of claim 2 wherein the carrier belt is rubberized or comprises a rubber.

4. The system of claim 2 wherein the carrier belt is texturized.

5. The system of claim 2 wherein the belt is a tacky polymer material.

6. The system of claim 1 wherein the temporary support is a multiple use reusable liner that is operable from a liner unwind roller through the digital printer to a liner rewind roller, the reusable liner providing temporary support to the water soluble film during transport through the digital printer.

7. The system of claim 1 wherein the temporary support is a heated platen disposed between two spread rollers, the heated platen provides temporary support to the water-soluble film during transport through the digital printer.

8. The system of claim 1 further comprising at least one nip roller for providing intimate contact between the water-soluble film and the temporary support prior to transport through the digital printer.

9. The system of claim 8 wherein the temporary support is a carrier belt or a multiple use reusable liner.

10. The system of claim 1 wherein the powered rewind is motor driven.

11. The system of claim 1 wherein the tensioned rewind is brake controlled.

12. The system of claim 1 wherein the water-soluble film comprises polyvinyl alcohol.

13. The system of claim 1 wherein the water-soluble polymer film has a thickness of about 30 microns to about 50 microns and a width of about 12 inches to about 120 inches.

14. The system of claim 13 wherein the water-soluble film as a thickness of about 35 microns to about 45 microns.

15. The system of claim 1 further comprising a hydrographic dipping station inline with the digital printer.

16. A method for producing a linerless water-soluble film comprising a digitally printed hydrographic, the method comprising:
providing a source roll comprising linerless water-soluble film, the source roll disposed on an unwind roller;
providing a temporary support for the water soluble film extending a partial distance between the unwind roller and a powered rewind roller and through a digital printer;
transporting the linerless water-soluble film over the temporary support and through the digital printer wherein a hydrogaphic image is digitally printed onto the water-soluble film; and
winding the linerless water-soluble film comprising the digitally printed hydrographic onto the powered rewind roller.

17. The method of claim 16 wherein the temporary support comprises a moving belt or a temporary liner disposed about a liner unwind roller and a liner rewind roller, the water-soluble film is brought into intimate contact with the temporary support with a nip roller.

18. The method of claim 16 wherein the temporary support is a heated platen.

19. The method of claim 16 wherein the hydrographic image is digitally printed onto the water-soluble film with a solvent-based ink.

20. The method of claim 16 further comprising a hydrographic dipping tank inline with the digital printer, the method further comprising applying an activator to the water-soluble polymer film and disposing said film in a dipping tank wherein the water soluble film becomes liquefied, and dipping an article into said dip tank wherein the hydrographic design is transferred onto the article.
